(19) United States
(12) Patent Application Publication
(10) Pub. No.: US 2013/0057516 A1
(43) Pub. Date: Mar. 7, 2013

(54) OPTICAL TOUCH-CONTROL SYSTEM WITH TRACK DETECTING FUNCTION AND METHOD THEREOF

(71) Applicants: Chih-Hung Lu, Hsin-Chu City (TW); Chih-Yen Wu, Hsin-Chu City (TW); Hsin-Chia Chen, Hsin-Chu City (TW)

(72) Inventors: Chih-Hung Lu, Hsin-Chu City (TW); Chih-Yen Wu, Hsin-Chu City (TW); Hsin-Chia Chen, Hsin-Chu City (TW)

(21) Appl. No.: 13/351,236

(22) Filed: Jan. 17, 2012

(30) Foreign Application Priority Data
Sep. 7, 2011 (TW) 100132209

(51) Int. Cl. G06F 3/042

(52) U.S. Cl. 345/175

(57) ABSTRACT

The optical touch-control system processing track detection includes a light source for emitting a specific light; a sensing array for sampling the specific light reflected by an instruction object in a predetermined period of time for accordingly generating a first and a second sensing image signals; a motion detector for determining the track of the instruction object for outputting a motion vector signal according to the first and the second sensing image signals; and a processor for controlling movement of a target object according to the motion vector signal and the predetermined period of time; wherein the instruction object moves within a first zone of the sensing array.

### BACKGROUND OF THE INVENTION

1. Field of the Invention

The present invention relates to a touch-control system, and more particularly, to an optical touch-control system with track detecting function.

2. Description of the Prior Art

A standard touch-control system includes a touch panel, a processing device, and a display panel. Via the processing device, when a user moves his finger on the touch panel, an object (such as a cursor) will move within the display panel. In the prior art, movement of the user's finger directly corresponds to movement of the cursor; in other words, the touch panel must be the same size of the display panel, which raises production costs. In order to reduce the size of the touch panel (and thereby reduce production costs), movement of the cursor will correspond to movement of a finger multiplied by a fixed constant. This multiplication will decrease accuracy of the touch panel, however. In the first situation, if the touch panel has a width X and the user wants to move the cursor a distance 2X to the right, he must move his finger across the touch panel twice. In the second situation, by multiplying the detected movement of the finger on the touch panel by two, the user only needs to move his finger across the display panel once. Although the second situation is simpler, the accuracy of the touch panel is still decreased. Therefore, when producing touch-control systems, the dual problems of reducing costs while increasing accuracy must be solved.

### SUMMARY OF THE INVENTION

It is therefore an objective of the present invention to provide an optical touch-control system with a track detecting function.

The present invention discloses an optical touch-control system processing track detection for moving an objective within a display panel according to a detected track, the optical touch-control system comprising a light source for emitting a specific light; a sensing array for continuously sampling the specific light reflected by an instruction object in a predetermined period, to accordingly generate a first image signal related to a first sensing image signal and a second image signal related to a second sensing image signal; and a motion detector for outputting a motion vector signal to determine the track of the instruction object according to the first sensing image signal and the second sensing image signal; wherein the instruction object moves within a first zone of the sensing array.

The present invention further discloses a method for controlling an optical touch-control system to move an objective within a display panel according to a detected track, the method comprising continuously sampling a specific light reflected by an instruction object in a predetermined period, to accordingly generate a first image signal related to a first sensing image signal and a second image signal related to a second sensing image signal; and outputting a motion vector signal to determine the track of the instruction object according to the first sensing image signal and the second sensing image signal; wherein the instruction object moves within a first zone of the sensing array.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an optical touch-control system with track detecting function according to an embodiment of the present invention.

FIG. 2 illustrates a schematic diagram of the optical touch-control system of the present invention for moving an objective according to movement, angle and velocity information of the instruction object.

FIG. 3 illustrates a schematic diagram of the optical touch-control system of the present invention for moving an objective according to movement, angle and acceleration information of the instruction object.

FIG. 4 illustrates a schematic diagram showing that, when the position of the instruction object is located in a specific zone, the optical touch-control system of the present invention moves the objective in other ways.

FIGS. 5A and 5B illustrate schematic diagrams of a relationship between the touch-control panel and the display panel in the optical touch-control system of the present invention.

### DETAILED DESCRIPTION

An optical touch-control system of the present invention may include a processor or be coupled to a processor for controlling movement of an objective in a display panel.

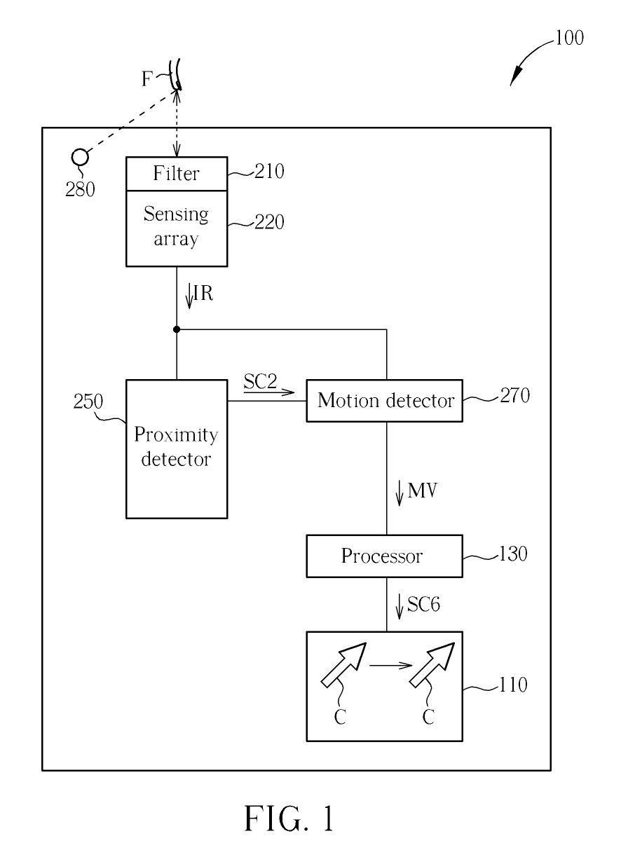

Please refer to FIG. 1, which illustrates a schematic diagram of an optical touch-control system 100 with track detecting function according to an embodiment of the present invention. In this embodiment, the optical touch-control system 100 includes the processor. The optical touch-control system 100 further includes a filter 210, a sensing array 220, a proximity detector 250, a motion detector 270, a light source 280, a processor 130 and a display panel 110. In this embodiment, the touch-control panel is defined by a combination of the filter 210 and the sensing array 220.

The filter 210 is utilized for filtering a specific range of wavelengths, such as the range of visible light. In this case, the sensing array 220 senses the lights which are not filtered by the filter 210, i.e. the invisible lights, and the source 280 therefore emits the invisible lights. When a user wants to move a cursor C (an objective) on the display panel 110, he will move his finger F (an instruction object) close to the optical touch-control panel (including the filter 210 and the sensing array 220), and the finger F can be sensed by the sensing array 220 without being blocked by the filter 210.

The user can move his finger F to accordingly move the cursor C. At this moment, lights emitted from the light source 280 are reflected by the finger F to arrive at the sensing array 220. Due to the additionally disposed filter 210 of the sensing array 220, the lights sensed by the sensing array 220 can be determined to be emitted from the light source 280 and reflected by the finger F, such that the sensing array can continuously sample the specific lights reflected by the finger F in a predetermined period to accordingly generate a first sensing image signal and a second sensing image signal.

Therefore, by using the invisible lights emitted from the light source 280, the finger F can be imaged onto the sensing array 220 to generate a sensing image signal IR. A shape of the sensing image signal IR can be, for example, a fingerprint shape. The proximity detector 250 can determine a distance D1 between the finger F and the sensing array 220 according to the sensing image signal IR, to accordingly generate a control signal SC2 to switch on/off the motion detector 270.

In detail, the proximity detector 250 can determine the distance D1 between the finger F and the sensing array 220 according to light intensities of the sensing image signal IR. When the determined distance D1 is larger than an instruction distance, it means that the finger F is not close to the sensing array 220. At this moment, there is no need for motion detection and the control signal SC2 will turn off the motion detector 270 to save electrical power. When the determined distance D1 is smaller than the instruction distance, this means that the finger F is close to the sensing array 220; there is therefore a need for motion detection and the control signal SC2 will turn on the motion detector 270.

The motion detector 270 is utilized for receiving the sensing image signal IR generated by the sensing array 220, to determine movement of the finger (i.e. a moving distance information and a moving direction information) to generate a motion vector signal MV according to differences between a plurality of continuous sensing image signals IR. The motion vector signal MV includes the moving distance information (a relative distance) and a moving angle of the finger F.

The sensing array 220, in practice, will sample the finger F with a fixed sampling rate. Therefore, differences between the two neighbor sensing image signals IR1 and IR2 (not shown in the diagram) will form the motion vector signal MV. In other words, the motion detector 270 can subtract the previous sensing image signal IR1 from the later sensing image signal IR2 to obtain the motion vector signal MV of the finger F. Furthermore, on the basis of the sampling rate of the sensing array 220, a period between the neighbor sensing image signals IR1 and IR2 is known. According to the motion vector signal MV and the period between the neighbor sensing image signals IR1 and IR2, velocity information and acceleration information of the moving finger F are known.

The processor 130 receives the motion vector signal MV to fit in a predetermined algorithm in order to generate a control signal SC6, so as to move the cursor C on the display panel 110. For example, the processor 130 can be designed to move the cursor C according to the motion vector signal MV and the velocity information of the moving finger F, or according to the motion vector signal MV and the acceleration information of the moving finger F, wherein the acceleration information is acquired by analyzing the velocity information.

The processor 130 can also be coupled to the sensing array 220 (not shown in the diagram). Since information (i.e. the motion vector signal MV) obtained from the motion detector 270 is not enough to provide a real position of the finger F (i.e. the position of the finger on the touch-control panel), the processor 130 needs to directly receive the sensing image signal IR in order to know the real position of the finger F. The benefit of knowing the real position of the finger F is that the processor 130 can further control movement of the cursor C according to the position of the finger F.

The following figures are utilized as examples for operation of the optical touch-control system 100 of the present invention. In these figures, an overview of the optical touch-control system 100 is shown, and the filter 210 is omitted for brevity. The following embodiment only represents the sensing array 220 sampling two neighboring sensing image signals to obtain the motion vector signal MV. An operation with multiple sensing image signals can be inferred from this embodiment and is therefore not described herein.

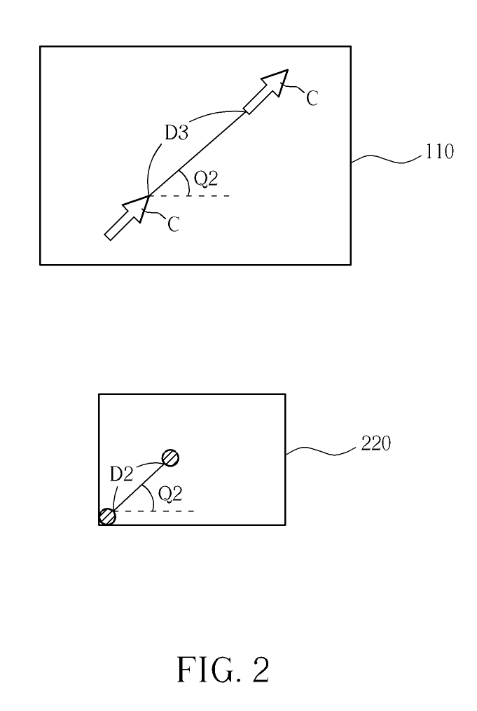

Please refer to FIG. 2, which illustrates a schematic diagram of the optical touch-control system 100 of the present invention for moving the objective according to movement, angle and velocity information of the instruction object. As shown in FIG. 2, the motion vector signal MV represents the finger F moving a distance D2 at an angle Q2. Originally, the cursor C will move in exactly the same way as the finger F, i.e. moving a distance D2 at the angle Q2. The processor 130 further increases movement of the cursor C to a distance D3 according to the velocity information V of the finger F (i.e. V=D2/T, wherein the symbol T represents the sampling rate of the sensing array 220). The relationship between the distance D2, D3 and the velocity information V can be represented by the following formula: D3=D2*V*C=D2*(D2/T)*C=C*D2²/T, wherein the symbol C is a constant. For example, supposing that the constant C equals 1, if the user's finger F moves with a fixed velocity information for 10 centimeters (D2) within 5 seconds (T), the cursor C will move a distance of 20 centimeters (D3=10²/5). If the user's finger F moves with a fixed velocity information for 10 centimeters (D2) within 2 seconds (T), the cursor C will move a distance of 50 centimeters (D3=10²/2).

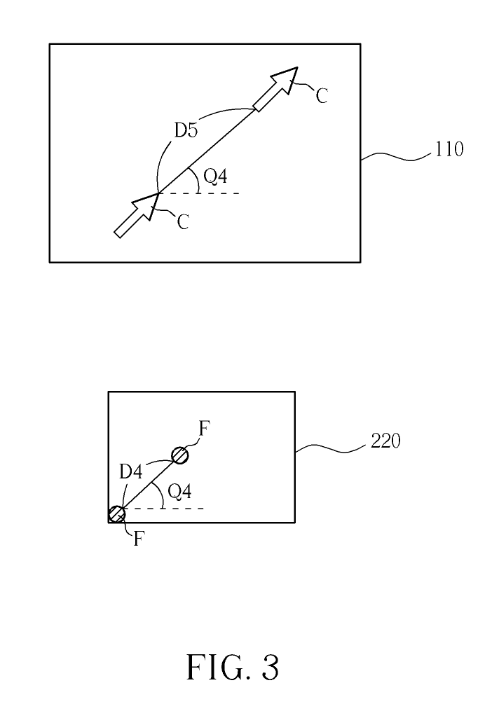

Please refer to FIG. 3, which illustrates a schematic diagram of the optical touch-control system 100 of the present invention for moving the objective according to movement, angle and acceleration information of the instruction object. As shown in FIG. 3, the motion vector signal MV represents the finger F moving a distance D4 at an angle Q4. Originally, the cursor C will move in exactly the same way as the finger F, i.e. moving a distance D4 at the angle Q4. The processor 130 further increases movement of the cursor C to a distance D5 according to the acceleration information E of the finger F (i.e. E=D2/T², wherein the symbol T represents the sampling rate of the sensing array 220). The relationship between the distance D4, D5 and the acceleration information E can be represented by the following formula: D5=D4*E*C=D4*(D4/T²)*C=C*D4²/T², wherein the symbol C is a constant. For example, supposing that the constant C equals 1, if the user's finger F accelerates from 0 to move for 10 centimeters (D4) within 5 seconds (T), the cursor C will move a distance of 4 centimeters (D5=10²/5²). If the user's finger F accelerates from 0 to move for 10 centimeters (D4) within 2 seconds (T), the cursor C will move a distance of 25 centimeters (D5=10²/2²).

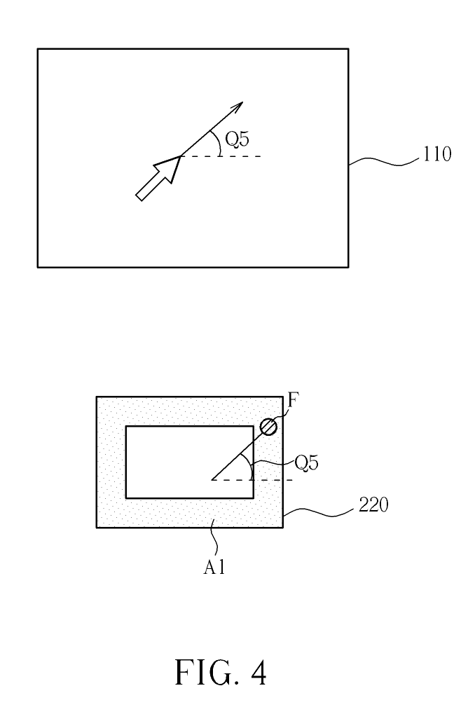

Please refer to FIG. 4, which illustrates a schematic diagram illustrating when the position of the instruction object is located at a specific zone, the optical touch-control system 100 of the present invention moves the objective in other ways. As shown in FIG. 4, the present invention can define the zone A1 as a specific zone in order to process another way of moving the objective. When the finger F pauses within the zone A1, the processor 130 can set the cursor C to continuously move according to the previous moving direction, and the moving velocity information can be set to be the previous moving velocity information or predetermined velocity information, which is not limited. The sensing array can be divided into a first zone and a second zone. When the instruction object moves in the first zone, the sensing array continuously outputs the motion vector signal to move the objective. When the instruction object moves into the second zone of the sensing array and pauses within the second zone, the objective will continuously move according to the motion vector signal of the paused instruction object.

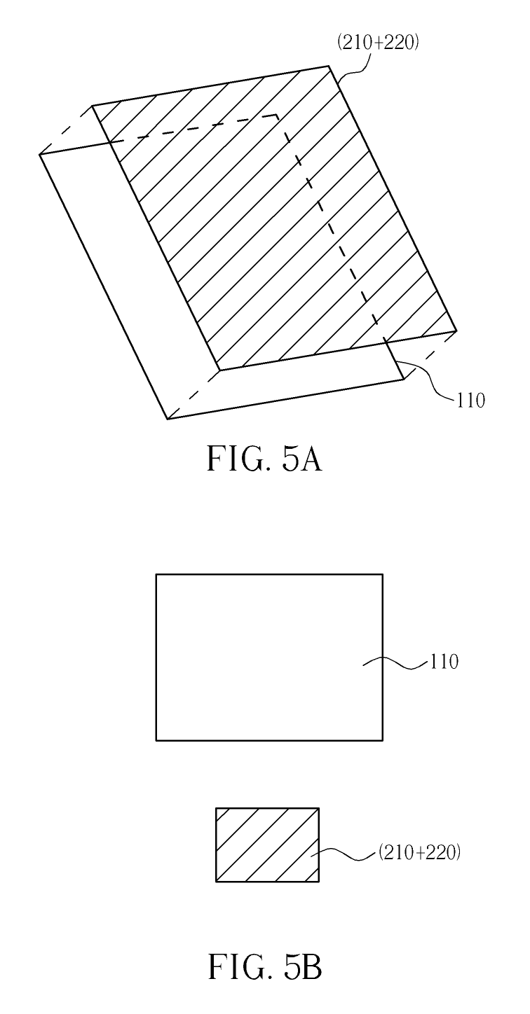

Please refer to FIGS. 5A and 5B, which illustrate schematic diagrams of a relationship between the touch-control panel and the display panel in the optical touch-control system of the present invention. FIG. 5A illustrates that there is an overlapping area between the optical touch-control panel and the display panel, i.e. the optical touch-control panel is disposed onto the display panel. This kind of realization is widely used in intelligent mobile phones. FIG. 5B illustrates that there is no overlapping area between the optical touch-control panel and the display panel. This kind of realization is widely used in notebooks. The optical touch-control system of the present invention can be realized by means of FIG. 5A or FIG. 5B, i.e. it can be applied to intelligent mobile phones, notebooks, or other electrical devices. The embodiment shown in FIG. 5A is called a direct contact, and functions used by the processor 130 can be linear functions. Preferably, the cursor C will move by a same amount as the finger F, or with a multiple ratio. The embodiment shown in FIG. 5B is called an indirect contact, and functions used by the processor 130 can be nonlinear functions. Preferably, movement of the cursor C can be larger than the movement of the finger F.

The user can combine or amend embodiments illustrated in FIGS. 2 to 4, such as considering the velocity information as well as the acceleration information at the same time, or only considering the angle information within the specific zone. Those skilled in the art can infer similar modifications from the above; they are therefore not detailed here.

In summary, the present invention discloses an optical touch-control system which can selectively move a displayed objective (cursor) according to at least velocity information or acceleration information of an instruction object (a finger). Therefore, when a user wants to move the cursor by a larger distance, the user can move his finger with a faster velocity to move the cursor a larger distance. Alternatively, the user can move the finger into a specific zone to make the cursor continuously move towards the same direction. The present invention can therefore achieve the objectives of reducing the size of the display panel (i.e. reducing the size of a sensing array/filter) as well as maintaining precision, so as to increase the ease with which a user can operate the optical touch-control system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical touch-control system processing track detection for moving an objective within a display panel according to a detected track, the optical touch-control system comprising:
a light source for emitting a specific light;
a sensing array for continuously sampling the specific light reflected by an instruction object in a predetermined period, to accordingly generate a first image signal related to a first sensing image signal and a second image signal related to a second sensing image signal; and
a motion detector for outputting a motion vector signal to determine the track of the instruction object according to the first sensing image signal and the second sensing image signal;
wherein the instruction object moves within a first zone of the sensing array.

2. The optical touch-control system of claim 1, further comprising a processor for controlling the movement of the objective according to the motion vector signal and the predetermined period.

3. The optical touch-control system of claim 1, further comprising:
a proximity detector for determining an instruction distance between the instruction object and the optical touch-control system;
wherein the motion detector is turned off when the proximity detector determines the instruction distance is larger than a predetermined value.

4. The optical touch-control system of claim 1, wherein the motion vector signal comprises a moving distance information and a moving direction information, the moving direction information is for moving the objective, and the moving distance information and the predetermined period are for generating a velocity information to move the objective according to the velocity information and the moving distance information.

5. The optical touch-control system of claim 1, wherein when the instruction object moves into a second zone of the sensing array and pauses within the second zone, the objective will continuously move according to the motion vector signal of the paused instruction object.

6. The optical touch-control system of claim 5, wherein the objective continuously moves according to a predetermined velocity information.

7. The optical touch-control system of claim 1, further comprising a filter located in the sensing array to filter out light which is not emitted from the light source.

8. A method for controlling an optical touch-control system to move an objective within a display panel according to a detected track, the method comprising:
continuously sampling a specific light reflected by an instruction object in a predetermined period, to accordingly generate a first image signal related to a first sensing image signal and a second image signal related to a second sensing image signal; and
outputting a motion vector signal to determine the track of the instruction object according to the first sensing image signal and the second sensing image signal;
wherein the instruction object moves within a first zone of the sensing array.

9. The method of claim 8, wherein controlling the movement of the objective according to the motion vector signal and the predetermined period, further comprises:
moving the objective according to a moving direction information of the motion vector signal;
generating a velocity information according to a moving distance information and the predetermined period of the motion vector signal; and
moving the objective according to the moving distance information and the velocity information.

10. The method of claim 8, further comprising:
detecting a distance between the instruction object and the optical touch-control system.

11. The method of claim 10, wherein when the distance between the instruction object and the optical touch-control system is larger than a predetermined value, stopping detecting the motion vector signal of the instruction object.

12. The method of claim 8, further comprising:
detecting a position of the instruction object related to the optical touch-control system; and
when the position locates and pauses within a specific zone of the optical touch-control system, the objective will continuously move according to the motion vector signal of the paused instruction object.

13. The method of claim 12, wherein the step of controlling the objective to continuously move comprises:
controlling the objective to continuously move according to a predetermined velocity information.
